(19) United States
(12) Patent Application Publication
(10) Pub. No.: US 2016/0342739 A1
(43) Pub. Date: Nov. 24, 2016

(54) METHOD AND APPARATUS FOR PROVIDING ELECTRONIC CHART USING ONTOLOGY

(71) Applicant: SAMSUNG SDS CO., LTD., Seoul (KR)

(72) Inventor: Tae Hwan JEONG, Seoul (KR)

(73) Assignee: SAMSUNG SDS CO., LTD., Seoul (KR)

(21) Appl. No.: 14/982,506

(22) Filed: Dec. 29, 2015

(30) Foreign Application Priority Data
May 20, 2015 (KR) 10-2015-0070181

(51) Int. Cl. G06F 19/00; G06F 17/24; G06F 3/0484; G06F 3/0486; G06F 17/21

(52) U.S. Cl. CPC G06F 19/322; G06F 3/0486; G06F 17/211; G06F 3/04845; G06F 3/04842; G06F 17/248

(57) ABSTRACT

A method for providing an electronic chart comprising, providing, by an electronic chart device, a user interface capable of moving a position of one or more corpora contained in the electronic chart to other position, receiving as an input, by the electronic chart device, a movement of the position of the one or more corpora through the user interface, and updating, by the electronic chart device, medical ontology based on one or more words contained in the one or more corpora.

### CROSS-REFERENCE TO RELATED APPLICATION

This application claims priority from Korean Patent Application No. 10-2015-0070181 filed on May 20, 2015 in the Korean Intellectual Property Office, and all the benefits accruing therefrom under 35 U.S.C. 119, the contents of which in its entirety are herein incorporated by reference.

### BACKGROUND

1. Technical Field

The present inventive concept relates to a method and an apparatus for providing an electronic chart in a medical field in which a patient's past medical history, doctor's medical opinion, result of medical tests, specifications of medical prescription and the like can be recorded.

2. Description of the Related Art

In recent years, along with a development in information technology, an electronic medical record (EMR) and an electronic health record (EHR) have been proposed to replace a conventional paper medical chart which has been handwritten.

However, a doctor who should treat a large number of patients in a short time in reality may not have time to create an electronic chart according to the EMR or EHR. Furthermore, it may not be easy to encode, based on medical standards, the electronic chart which is freely inputted by a doctor, and a medical treatment record may be partially omitted.

When the medical treatment record handwritten on paper medical chart by a doctor is input to an electronic chart by other person, the medical treatment record scribbled down by the doctor may not be easily interpreted by other person, and therefore, a correct input to the electronic chart cannot be ensured.

### SUMMARY

An embodiment of the present inventive concept provides a method and an apparatus for providing an electronic chart using ontology.

However, embodiments of the present inventive concept are not restricted to those set forth herein. The other embodiments of the present inventive concept which are not mentioned herein will become more apparent to a person skilled in the art to which the present inventive concept pertains by referencing the detailed description of the present inventive concept given below.

According to the embodiments of the present inventive concept, an automatic complete function or a template is provided by using ontology which has learned a manner of creating an electronic chart by each user or for each type of disease, thereby enabling a user to create an electronic chart in an easier way.

According to the embodiments of the present inventive concept, a user interface is provided to intuitively input and move corpus, and ontology can be automatically updated based on new corpus or result of movement of corpus.

In some embodiments, a method for providing an electronic chart comprising, providing, by an electronic chart device, a user interface capable of moving a position of one or more corpora contained in the electronic chart to other position, receiving as an input, by the electronic chart device, a movement of the position of the one or more corpora through the user interface, and updating, by the electronic chart device, medical ontology based on one or more words contained in the one or more corpora.

In some embodiments, the method for providing an electronic chart comprising, receiving as an input, by an electronic chart device, a character string for creating the electronic chart from a user, assigning, by the electronic chart device, identification codes to respective words contained in the character string on the basis of types of the words, extracting, by the electronic chart device, one or more corpora from medical ontology on the basis of the identification codes, and providing, by the electronic chart device, an automatic complete function by using the one or more corpora.

In some embodiments, the method for providing an electronic chart comprising, receiving as an input, by an electronic chart device, a type of a disease to be input into the electronic chart from a user, extracting, by the electronic chart device, a word based on the type of the disease from medical ontology, creating, by the electronic chart device, a template for creating the electronic chart on the basis of the extracted word, and outputting, by the electronic chart device, the template.

In some embodiments, a computer program recorded on a recording medium, the computer program being combined to a computing device so as to enable an electronic chart device to provide a user interface capable of moving a position of one or more corpora contained in an electronic chart to other position, enable the electronic chart device to receive as an input a movement of the position of the one or more corpora through the user interface, and enable the electronic chart device to update medical ontology based on one or more words contained in the one or more corpora.

In some embodiments, an electronic chart device comprising, one or more processors, a network interface, a memory, and a storage having a computer program recorded therein, the computer program being loaded to the memory and executed by the processors, wherein the computer program includes, an instruction for providing a user interface capable of moving a position of one or more corpora contained in an electronic chart to other position, an instruction for receiving as an input a movement of the position of the one or more corpora through the user interface, and an instruction for updating medical ontology based on one or more words contained in the one or more corpora.

### BRIEF DESCRIPTION OF THE DRAWINGS

FIG. 1 illustrates a configuration of an electronic chart system according to an embodiment of the present inventive concept;

FIG. 2 is a flowchart illustrating a method for providing an electronic chart according to an embodiment of the present inventive concept;

FIG. 3 illustrates an example of an identification code according to an embodiment of the present inventive concept;

FIG. 4 to FIG. 6 illustrate an example of an automatic complete function according to some embodiments of the present inventive concept;

FIG. 7 to FIG. 9 illustrate an example of a corpus selection method according to some embodiments of the present inventive concept;

FIG. 10 and FIG. 11 illustrate an example of a corpus movement method according to some embodiments of the present inventive concept;

FIG. 12 illustrates an example of a corpus deletion method according to an embodiment of the present inventive concept;

FIG. 13 is a flowchart illustrating a method for providing an electronic chart according to another embodiment of the present inventive concept;

FIG. 14 illustrates an example of an electronic chart template according to an embodiment of the present inventive concept;

FIG. 15 is a block diagram of an electronic chart device according to an embodiment of the present inventive concept; and

FIG. 16 illustrates a configuration of hardware of an electronic chart according to an embodiment of the present inventive concept.

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Several terms used herein will be explained prior to the description of an embodiment of the present inventive concept.

The term “ontology” may be used to describe a model in which a relation between concepts of a specific domain is formally described. Specifically, the medical ontology described hereinafter may be a model in which a relation between words in a medical field is formally described.

More specifically, the medical ontology may discriminatively store therein a relation between words for each user that creates an electronic chart or for each type of disease. That is, the medical ontology may be capable of learning a manner of creating an electronic chart by each user or for each type of disease. The medical ontology described above may be constituted by a class, an instance, a property and a relation.

The class herein may be used to describe a concept, an article or the like that belongs to a medical field. For example, the class may include a concept or an article that belongs to a medical field, such as a disease, a treatment method, clinical matters, medicine, a dosage or the like, but the present disclosure is not limited thereto.

The instance herein may be used to describe a substantial form of the class. For example, the instance may include a substantial form of a class, such as diabetes, aspiration, aspirin, 1000 cc or the like, but the present disclosure is not limited thereto.

The property herein may be used to describe a feature or a characteristic of the class or the instance. For example, the property may include a feature or a tendency of the class of the instance, such as “Aspirin has effects of fever alleviation, pain relief, anti-inflammation and the like”, but the present disclosure is not limited thereto.

The relation herein may be used to describe a relation between the classes, or the instances. For example, the relation may include a relation between the classes, or the instances, such as “The dosage is 1000 cc”, but the present disclosure is not limited thereto.

Medical ontology may capable of learning a manner of creating an electronic chart based on words included in the international statistical classification of diseases and related health problems (ICD), logical observation identifiers names and codes (LOINC), systematized nomenclature of medical clinical terms (SNOMED-CT), US-specific terminology in medicine (i.e., RxNorm) and the like, but the present disclosure is not limited thereto.

Unless otherwise specified, all of the terms which are used herein (including the technical or scientific terms) may be used as meanings that are commonly understood by a person having ordinary knowledge in the art to which the present inventive concept pertains. The terms defined in a generally used dictionary are not to be construed to have ideal or excessive meanings unless they are obviously specified in the present disclosure.

Now, the present inventive concept will be explained in more detail with reference to the attached drawings.

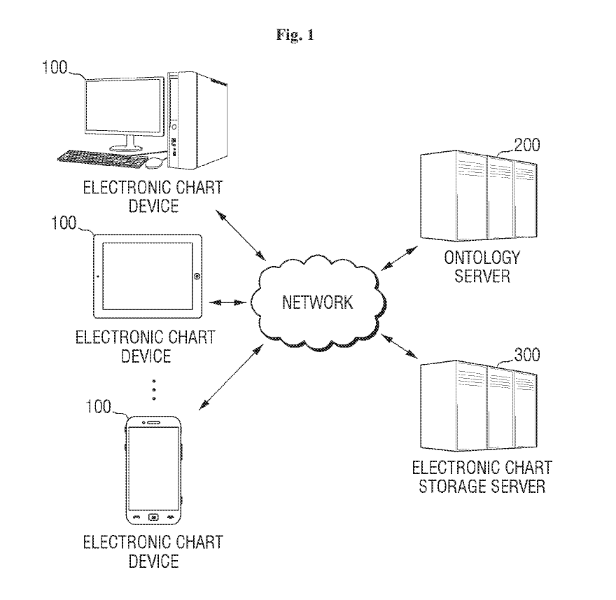

FIG. 1 illustrates a configuration of an electronic chart system according to an embodiment of the present inventive concept. The electronic chart system shown in FIG. 1 may provide an automatic complete function by using medical ontology in creating an electronic chart and update the medical ontology by using a relative position of corpus included in the electronic chart. Components of the electronic chart system represent respective functional elements differentiated in terms of function, and any one or more components may be integrated in an actual physical environment.

Each component of the electronic chart system according to an embodiment of the present inventive concept will be explained in detail hereinafter. An electronic chart device 100 is a computing device which may provide an automatic complete function when a user creates an electronic chart and update medical ontology by using a relative position of corpus included in the electronic chart. In this case, the user may include a doctor, a nurse, a nurse' aide, and the like who intends to create an electronic chart using the electronic chart device 100, but the present disclosure is not limited thereto. The electronic chart is the one in which a patient's past medical history, a doctor's medical opinion, result of medical tests, specifications of medical prescription and the like are created by a computing device. A corpus is a collection or words constituted by one or more words. The corpus may include one or more words, one or more sentences or one or more paragraphs.

The electronic chart device 100 may include any device that can output a user interface (UI) and transmit/receive data through a network. For example, the electronic chart device 100 may be a fixed computing device such as a desktop, a server, a workstation and the like, or a mobile device such as a laptop, a smartphone, a tablet, a phablet and the like.

An ontology server 200 is the one in which medical ontology is implemented. More specifically, the medical ontology server 200 may receive, from one or more electronic chart devices 100, one or more words and a relation between one or more words included in the electronic chart so as to update the medical ontology. Furthermore, the medical ontology server 200 may provide a corpus for implementing an automatic complete function in response to a request from one or more electronic chart devices 100. The medical ontology server 200 according to an embodiment of the present inventive concept may be implemented as a server separated from the electronic chart device 100, however, the medical ontology server 200 according to another embodiment of the present inventive concept may be implemented as being coupled to each of the electronic chart devices 100.

An electronic chart storage server 300 may receive the created electronic chart from one or more electronic chart devices 100 and manage the received electronic chart.

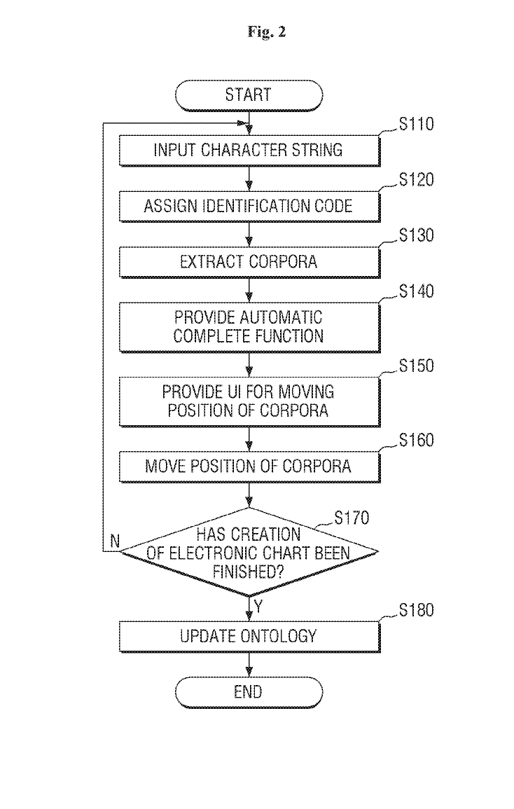

A method for providing an electronic chart according to an embodiment of the present inventive concept will now be described in more detail with reference to FIG. 2. FIG. 2 is a flowchart illustrating a method for providing an electronic chart according to an embodiment of the present inventive concept.

Referring to FIG. 2, the electronic chart device 100 may receive a character string for creating an electronic chart from a user (S110). In this case, the character string may have a natural language format. Furthermore, the character string may include a word root or one or more words, but the present disclosure is not limited thereto. The electronic chart device 100 may take, as an input, a character string from a user through a physical keyboard, a virtual keyboard output through a touch screen, a stylus pen or the like, but the present disclosure is not limited thereto.

The electronic chart device 100 may then assign an identification code to each word included in the character string according to the type of the word based on an identification code DB (S120). In this case, the identification code DB may store therein identification codes defined in international statistical classification of diseases and related health problems (ICD), logical observation identifiers names and codes (LOINC), systematized nomenclature of medical clinical terms (SNOMED-CT), US-specific terminology in medicine (i.e., RxNorm) and the like, but the present disclosure is not limited thereto. For example, the term “stomach cancer” may be assigned with an identification code ICD-10-CM: C16.9″ according to ICD.

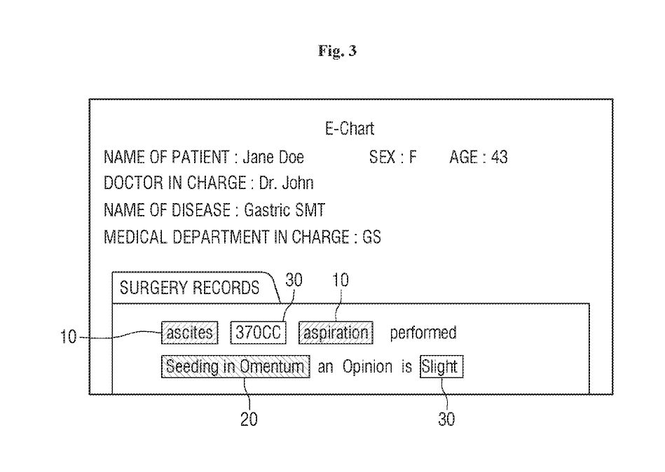

Furthermore, the electronic chart device 100 may output each word having an identification code assigned thereto in colors differentiated by the type of the assigned identification codes. An embodiment of an identification code output in differentiating colors will be described in detail with reference to FIG. 3 later.

The electronic chart device 100 then extracts one or more corpora from the medical ontology based on the identification code assigned to each word included in the character string (S130). More specifically, the electronic chart device 100 extracts one or more corpora expected to be input to an electronic chart by a user from the medical ontology based on the identification code assigned to each word included in the character string.

In this case, the corpora expected to be input by a user may include the word extracted from the medical ontology based on the identification code assigned thereto among the words that can be completed in association with the character string. Furthermore, the corpora expected to be input by a user may include the paragraph extracted from the medical ontology based on the identification code assigned thereto among the paragraphs that can be completed in association with the character string.

That is, the electronic chart device 100 may extract, from the medical ontology, corpora including words, sentences or paragraphs expected to be input by a user based on the character string input by the user.

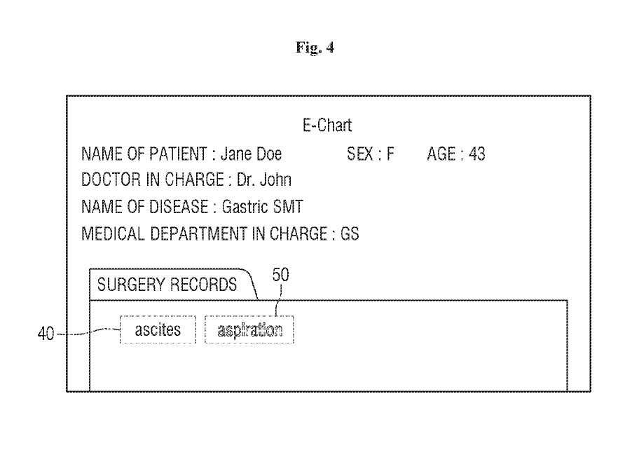

The electronic chart device 100 may then provide an automatic complete function using the extracted one or more corpora (S140). In this case, the automatic complete function outputs, prior to an input by a user, one or more corpora including words, sentences or paragraphs expected to be input by the user. Some embodiments regarding the automatic complete function will be explained in detail with reference to FIG. 4 to FIG. 6 later.

The electronic chart device 100 may provide a user interface (UI) which enables the position of one or more corpora output by an automatic complete function to freely move (S150). In this case, the UI enables the user to intuitively select one or more corpora and move the position of the selected corpora through an input device such as a mouse, a touch screen, a touch pad, a track ball and the like.

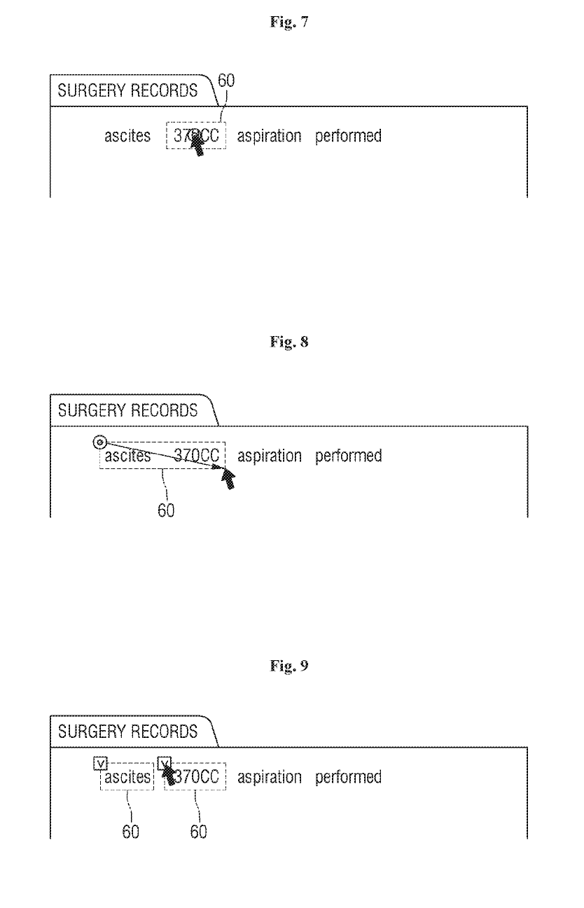

The electronic chart device 100 may take, as an input, a movement of the position of one or more corpora through the UI (S160). More specifically, the electronic chart device 100 may take, as an input, the selection of the corpus to be moved among one or more corpora through the UI. In this case, the input for selecting the corpus to be moved may be a click or touch input for the corpus to be moved among one or more corpora. Furthermore, the input for selecting the corpus to be moved may be a drag input to the corpus to be moved among one or more corpora. Furthermore, the input for selecting the corpus to be moved may be a tick input in a check box corresponding to the corpus to be moved among the check boxes corresponding to respective one or more corpora. Some embodiments regarding the corpora selection method will be explained in detail with reference to FIG. 7 to FIG. 9 later.

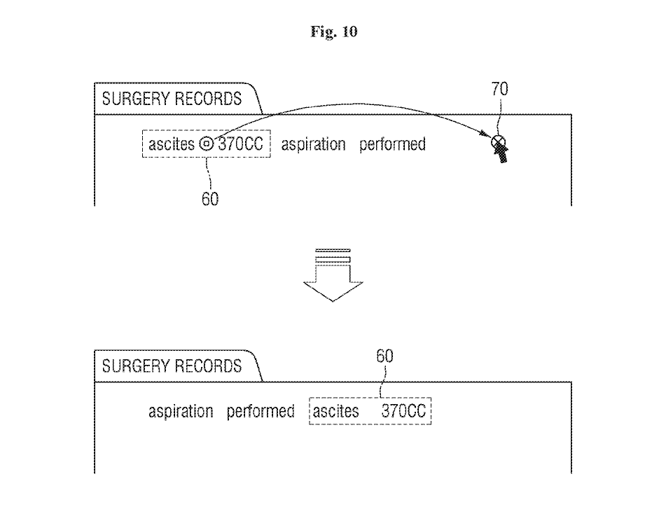

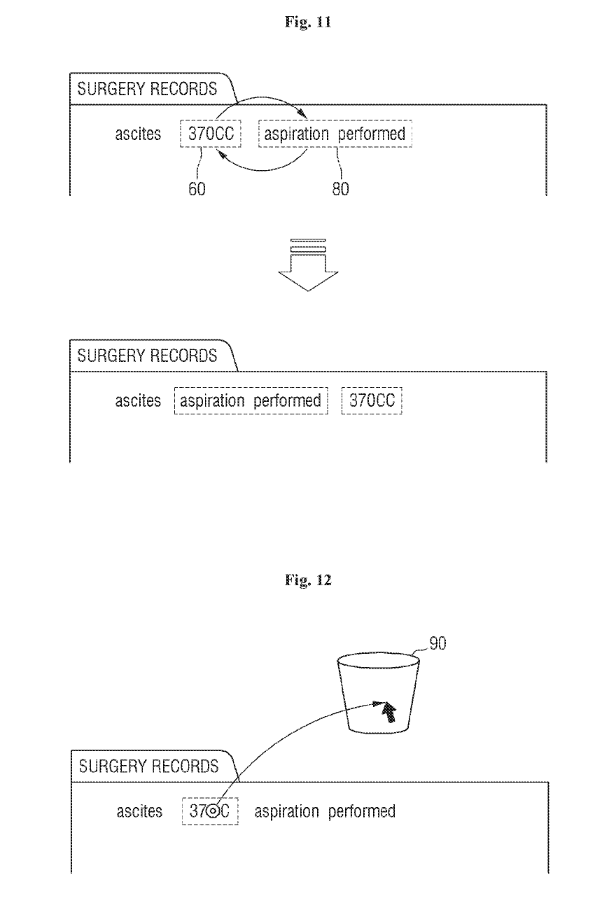

The electronic chart device 100 may separate the selected corpus from the unselected corpus, and take, as an input, for moving the selected corpus to a new position. In this case, the input for moving the selected corpus to a new position may be a drag and drop input for the selected corpus. Furthermore, the input for moving the selected corpus to a new position may be an input of a preset key performed after the corpus to be moved has been selected. For example, the preset key may be an arrow key on a keyboard, but the present disclosure is not limited thereto. When the preset key is input, the electronic chart device 100 may swap the relative positions between the selected corpus and the corpus adjacent to the selected corpus. Some embodiments regarding the corpus movement method will be explained in detail with reference to FIG. 10 to FIG. 11 later.

The electronic chart device 100 may take, as an input, a deletion of one or more output corpora through the UI. More specifically, the electronic chart device 100 may delete the selected unnecessary corpus when the unnecessary corpus is selected and moved to a preset region through the drag and drop input. In this case, the preset region may be represented in an image of a wastebasket so as to allow the user to intuitively recognize that the region is relevant to a region to be deleted, but the present disclosure is not limited thereto. Furthermore, the electronic chart device 100 may delete a selected unnecessary corpus when the unnecessary corpus is selected and a preset key is input. For example, the preset key may be a delete key or the like on a keyboard, but the present disclosure is not limited thereto. The corpus deletion method described above will be explained in detail with reference to FIG. 12 later.

The electronic chart device 100 may further take, as an input, a character string after taking, as an input, the movement of the position of one or more corpora. For example, a user may further input the dose of an administered medicine when the corpus including administration of medicine is output by the electronic chart device 100 according to an automatic complete function. Furthermore, the electronic chart device 100 may output a message indicating an omission of an item from the electronic chart based on the medical ontology when a character string expected to be further input by the user is not input. For example, when the electronic chart device 100 has output a corpus including administration of medicine according to an automatic complete function but a user has not further input a dose of the administered medicine, the electronic chart device 100 may output a message indicating the omission of a further input of the dose.

The electronic chart device 100 may then determine whether the creation of the electronic chart is finished (S170). For example, the electronic chart device 100 may determine that the creation of the electronic chart is finished when a “creation finished” button is pressed by the user. If it is determined that the creation of the electronic chart is not finished, the electronic chart device 100 may continue to take, as an input, the character string from the user.

If it is determined that the creation of the electronic chart is finished, the electronic chart device 100 may update the medical ontology based on one or more words included in the corpus (S180). More specifically, if a word corresponding to an instance which is not stored in the medical ontology is included in the corpus, the electronic chart device 100 may add the word as a new instance to the medical ontology. Furthermore, the electronic chart device 100 may update a relation between the classes, or the instances corresponding to two or more words stored in the medical ontology based on a relative distance between two or more words included in the corpus.

That is, the electronic chart device 100 may analyze a relation between corpora based on the new position of the corpus moved in accordance with the input by the user so as to update the medical ontology. Since the input by the user to move the corpus may include the definite intention of the user, the input may be regarded as a significant clue in updating the medical ontology. Furthermore, the electronic chart device 100 may update the medical ontology based on the corpora which have been moved differently by the respective users, thereby constructing the medical ontology personalized for each user.

In sum, the method for providing an electronic chart according to an embodiment of the present inventive concept may provide an automatic complete function which enables a user to easily input a corpus by using medical ontology. Furthermore, the method for providing an electronic chart may provide a UI which enables an intuitive input or movement of a corpus. Furthermore, the method for providing an electronic chart may automatically update the medical ontology based on a new corpus or a result of the movement of the corpus. Thus, the medical ontology may be capable of automatically learning a manner of creating an electronic chart by each user or for each type of disease without necessitating a manual update of the medical ontology by the user using an ontology web language (OWL) or the like.

An embodiment of an identification code according to an embodiment of the present inventive concept will be explained hereinafter. FIG. 3 illustrates an example of an identification code according to an embodiment of the present inventive concept.

Referring to FIG. 3, the electronic chart output by the electronic chart device 100 may include basic information of a patient such as the patient's name, sex and age, the name of the patient's disease, the name of the doctor in charge of the patient, the medical department in charge of the patient and the like. The electronic chart output by the electronic chart device 100 may include a free input field in which a user may freely input a character string. Although the free input field in which the user may input surgery records is shown in FIG. 3, the present disclosure is not limited thereto, and the electronic chart device 100 may include a free input field in which the user may input matters related to disease, medical observation records, clinical opinion, result of medical tests, prescriptions and the like.

The electronic chart device 100 may assign an identification code on a real time basis to each word included in the character string input by the user.

Specifically, an identification code 10 of “SCTID: 240290003” is assigned to “ascites” and “aspiration” according to the Systematized Nomenclature of Medicine Clinical Terms (SNOMED-CT) stored in the identification code DB. An identification code 20 of “ICD-10-CM: C78.6” is assigned to “seeding in omentum” according to the international statistical classification of diseases and related health problems (ICD) stored in the identification code DB. An identification code 30 representing a value is assigned to “370 cc” and “slight”.

Furthermore, the electronic chart device 100 may output each word having an identification code assigned thereto in colors differentiated by the type of the assigned identification codes. For example, “ascites” and “aspiration” to which the identification code 10 is assigned according to SNOMED-CT may be output to have a background of the word in a blue color. The word “seeding in omentum” to which the identification code 20 is assigned according to ICD may be output to have a background of the word in a green color. The words “370 cc” and “slight” to which the identification code 30 representing a value is assigned may be output to have backgrounds of the words in a red color.

As described above, the electronic chart device 100 according to an embodiment of the present inventive concept may output each word in colors differentiated by the type of the word contained in the input character string, thereby providing feedback for enabling the user of the electronic chart device 100 to check on a real time basis whether the character string input by himself/herself is correct.

Some embodiments according to the present inventive concept regarding an automatic complete function will be explained hereinafter. FIG. 4 to FIG. 6 illustrate an example of an automatic complete function according to some embodiments of the present inventive concept.

Prior to referring to FIG. 4, let it be assumed that the user of the electronic chart device 100 has inputted the word “aspiration” after the word “ascites” so as to create an electronic chart regarding a stomach cancer in the past, and the medical ontology has learned that the user inputs the phrase “ascites aspiration” when creating the electronic chart regarding a stomach cancer.

Referring to FIG. 4, the electronic chart device 100 may assign an identification code “SCTID: 240290003” to “ascites” when “ascites” is input from a user. The electronic chart device 100 may extract the word “aspiration” which is associated with “SCTID: 240290003” from the medical ontology. The electronic chart device 100 may automatically output “aspiration” to be connected to “ascites”.

Consequently, the user of the electronic chart device 100 may complete the phrase “ascites aspiration” without further inputting “aspiration” after inputting only “ascites”.

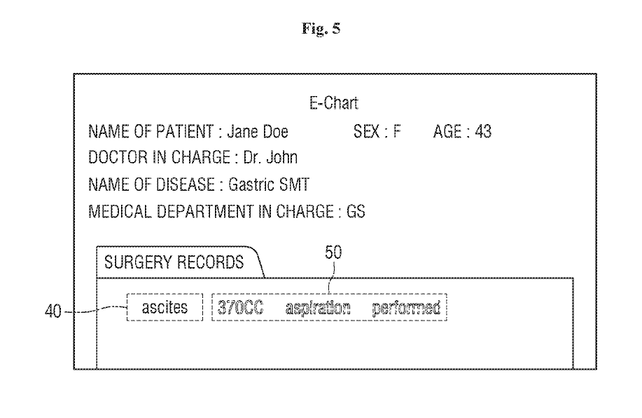

Prior to referring to FIG. 5, let it be assumed that the user of the electronic chart device 100 has inputted “370 cc aspiration performed” after the word “ascites” so as to create an electronic chart regarding a stomach cancer in the past, and the medical ontology has learned that the user inputs the expression “ascites, 370 cc aspiration performed” when creating the electronic chart regarding a stomach cancer.

Referring to FIG. 5, the electronic chart device 100 may assign an identification code “SCTID: 240290003” to “ascites” when “ascites” is input from a user. The electronic chart device 100 may extract the expression “370 cc aspiration performed” made up of words associated with “SCTID: 240290003” from the medical ontology. The electronic chart device 100 may automatically output “370 cc aspiration performed” to be connected to “ascites”.

Consequently, the user of the electronic chart device 100 may complete the expression “ascites, 370 cc aspiration performed” without further inputting “370 cc aspiration performed” after inputting only “ascites”.

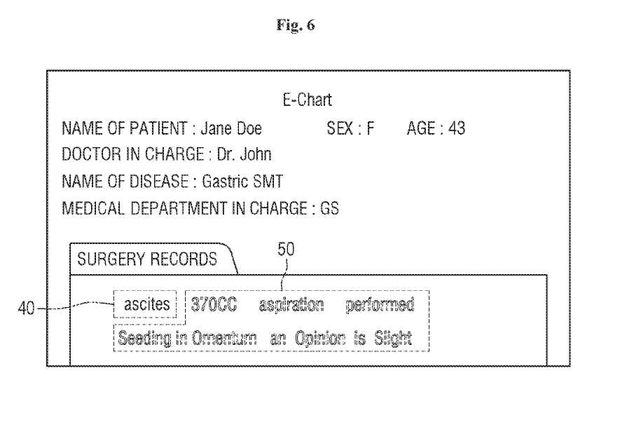

Prior to referring to FIG. 6, let it be assumed that the user of the electronic chart device 100 has inputted the sentence “370 cc aspiration performed, seeding in omentum, an opinion is slight” after the word “ascites” so as to create an electronic chart regarding a stomach cancer in the past, and the medical ontology has learned that the user inputs the sentence “370 cc aspiration performed, seeding in omentum, an opinion is slight” when creating the electronic chart regarding a stomach cancer.

Referring to FIG. 6, the electronic chart device 100 may assign an identification code “SCTID: 240290003” to “ascites” when “ascites” is input from a user. The electronic chart device 100 may extract the sentence “370 cc aspiration performed, seeding in omentum, an opinion is slight” made up of words associated with “SCTID: 240290003” from the medical ontology. The electronic chart device 100 may automatically output “370 cc aspiration performed, seeding in omentum, an opinion is slight” to be connected to “ascites”.

Consequently, the user of the electronic chart device 100 may complete the sentence “ascites, 370 cc aspiration performed, seeding in omentum, an opinion is slight” without further inputting “370 cc aspiration performed, seeding in omentum, an opinion is slight” after inputting only “ascites”.

As described above, the electronic chart device 100 according to an embodiment of the present inventive concept may use medical ontology which has learned a manner of creating an electronic chart by each user for each type of disease, thereby providing an automatic complete function based on the manner of creating an electronic chart preferred by a specific user for a specific disease, not an automatic complete function simply using generally input words.

A corpus selection method according to some embodiments of the present inventive concept will now be described. FIG. 7 to FIG. 9 illustrate an example of a corpus selection method according to some embodiments of the present inventive concept.

Referring to FIG. 7, the electronic chart device 100 may select, as a corpus to be moved, a corpus 60 located in a clicked or touched region when one or more corpora output on a screen are clicked or touched. In this case, the click is an event which can be occurred by pressing a mouse button, a touch pad button, a joystick button and the like. Furthermore, the touch is an event which can be occurred by contacting a user finger or a stylus pen onto a touch screen. As described above, the electronic chart device 100 may select one corpus by a click or touch input.

Referring to FIG. 8, the electronic chart device 100 may select, as a corpus to be moved, one or more corpus 60 contained in a drag region when one or more corpora output on a screen are dragged. As described above, the electronic chart device 100 may select a plurality of consecutive corpora at the same time by dragging.

Referring to FIG. 9, the electronic chart device 100 may select, as a corpus to be moved, one or more corpus 60 corresponding to the respective ticked check boxes when check boxes corresponding to the respective one or more corpora output on a screen are ticked. As described above, the electronic chart device 100 may select a plurality of discrete corpora at the same time by ticking in the check boxes.

A corpus movement method according to some embodiments of the present inventive concept will now be described. FIG. 10 and FIG. 11 illustrate an example of a corpus movement method according to some embodiments of the present inventive concept.

Referring to FIG. 10, the electronic chart device 100 may move the position of one or more corpora to a dropped position 70 when the selected one or more corpora 60 are dragged and dropped. Furthermore, the electronic chart device 100 may shift the corpus located subsequent to the selected one or more corpora 60 to a space emptied after moving the selected one or more corpora 60.

Referring to FIG. 11, the electronic chart device 100 may swap the relative positions between the selected one or more corpora 60 and an adjacent corpus 80 when one or more corpora 60 are selected and then a preset key is input.

Furthermore, the electronic chart device 100 may analyze the relation between the corpora on the basis of a new position of the moved corpora so as to update the medical ontology.

As described above, the electronic chart device 100 according to an embodiment of the present inventive concept may provide a user interface that can separate or combine corpora so that a user may intuitively create an electronic chart by a preferable manner.

A corpus deletion method according to an embodiment of the present inventive concept will now be described. FIG. 12 illustrates an example of a corpus deletion method according to an embodiment of the present inventive concept.

Referring to FIG. 12, the electronic chart device 100 may delete the selected unnecessary corpus 60 when the unnecessary corpus 60 is selected and then moved to a preset region 90 by a drag and drop input. In this case, the preset region 90 may be depicted in an image of a wastebasket and the like as shown in FIG. 12 so as to allow the user to intuitively recognize that the region is relevant to a region to be deleted.

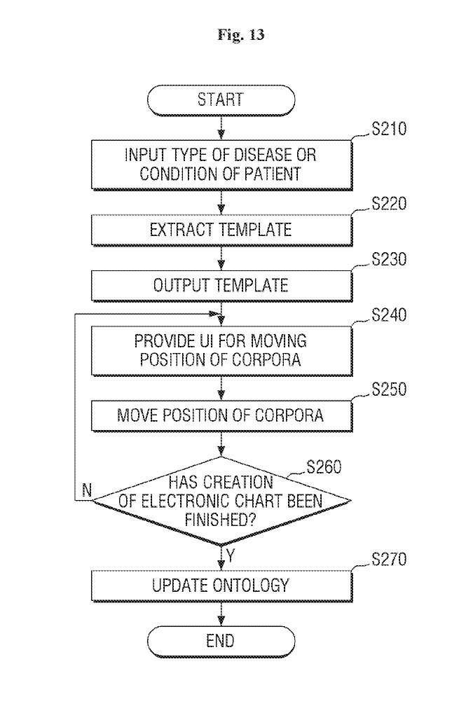

A method for providing an electronic chart according to another embodiment of the present inventive concept will now be described. FIG. 13 is a flowchart illustrating a method for providing an electronic chart according to another embodiment of the present inventive concept.

Referring to FIG. 13, the electronic chart device 100 may take, as an input, the type of the disease of a patient or the condition of a patient from a user (S210). In this case, the type of the disease and the condition of a patient may have a form of a natural language. Furthermore, the electronic chart device 100 may complete a corpus about the type of the disease or the condition of a patient when a character string is input from the user.

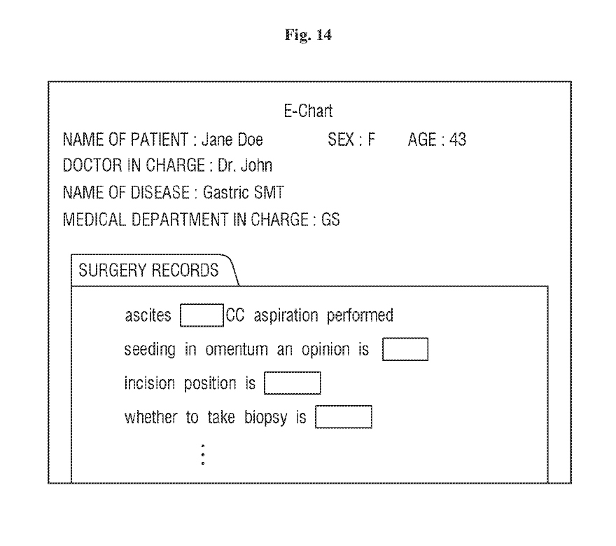

The electronic chart device 100 may then generate a template of an electronic chart on the basis of a medical ontology (S220). More specifically, the electronic chart device 100 may extract one or more words regarding the type of the disease of a patient or the condition of a patient from the medical ontology. In this case, the words extracted from the medical ontology may form a corpus that can be contained in an electronic chart expected to be created by a user with respect to a specific disease on the basis of the electronic chart that has been created by the user for each type of disease in the past. The electronic chart device 100 may create a template for creating an electronic chart by using the extracted words. In this case, the template is a format that includes the words extracted from the medical ontology so as to enable the user to easily create an electronic chart. The electronic chart device 100 may output the extracted template (S230). One embodiment of the template described above will be explained in detail with reference to FIG. 14 later.

The electronic chart device 100 may then provide a user interface that can freely move the position of one or more corpora output according to the template (S240). The electronic chart device 100 may then take, as an input, a movement of the position of one or more corpora through the user interface (S250). Since the user interface and the movement of the corpus in the method for providing an electronic chart according to another embodiment of the present inventive concept are the same as those described above with reference to FIG. 2, the description thereof will be omitted.

The electronic chart device 100 may then determine whether the creation of the electronic chart has been completed (S260). If it is determined that the creation of the electronic chart has not been completed, the electronic chart device 100 may continue to take, as an input, a movement of the position of the corpus from the user.

If it is determined that the creation of the electronic chart has been completed, the electronic chart device 100 may update the medical ontology on the basis of one or more words contained in the corpus (S270).

In sum, the method for providing an electronic chart according to another embodiment of the present inventive concept may provide a template adopting a manner of creating an electronic chart preferred by a user using medical ontology, thereby enabling the user to create an electronic chart through a maximum modification of the template.

A template according to an embodiment of the present inventive concept will now be described. FIG. 14 illustrates an example of an electronic chart template according to an embodiment of the present inventive concept.

Prior to referring to FIG. 14, let it be assumed that the user of the electronic chart device 100 has inputted the sentence including “ascites 370 cc aspiration performed”, “seeding in omentum, an opinion is slight”, “incision position is left below”, and “whether to take a biopsy is not decided” in an electronic chart of surgery records on a stomach cancer patient, and the medical ontology has learned that the user inputs the sentence “ascites 370 cc aspiration performed”, “seeding in omentum, an opinion is slight”, “incision position is left below”, and “whether to take a biopsy is not decided” when creating the electronic chart regarding surgery records of the stomach cancer patient.

Referring to FIG. 14, when a user has inputted “stomach cancer” as a type of disease of a patient, the electronic chart device 100 may extract, from the medical ontology, a template for the user to create an electronic chart of surgery records on a stomach cancer patient. The template for the user to create an electronic chart of surgery records on a stomach cancer patient may include corpora “ascites xxxcc aspiration performed”, “seeding in omentum, an opinion is xx”, “incision position is xx”, “whether to take a biopsy is xx” and the like as the medical ontology has learned.

The user of the electronic chart device 100 may then move the position of the corpus output according to the template and input an additional character string by using a user interface so as to create an electronic chart.

Although the template for inputting surgery records is depicted in FIG. 14, the present inventive concept is not limited thereto, and the electronic chart device 100 may output a template for inputting matters related to disease, medical observation records, clinical opinion, result of medical tests, prescriptions and the like.

The methods according to embodiments of the present inventive concept described thus far with reference to FIG. 2 to FIG. 14 may be performed by executing a computer program implemented in computer-readable codes. The computer program may be transmitted from a first computing device to a second computing device through a network such as Internet and installed in the second computing device so as to thereby be used in the second computing device. In this case, the first computing device and the second computing device may include all of a static computing device such as a desktop, a server and a workstation, a mobile computing device such as a smartphone, a tablet, a phablet and a laptop, and a wearable computing device such as a smart watch, smart glasses and a smart band.

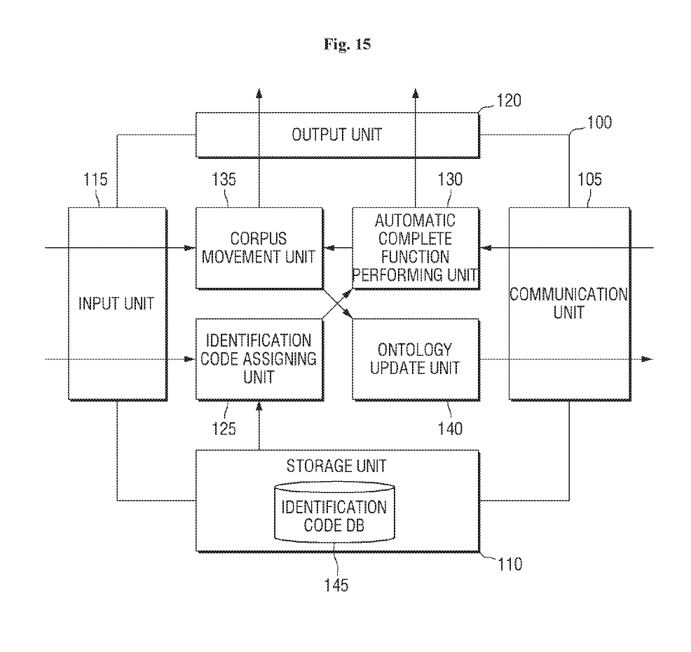

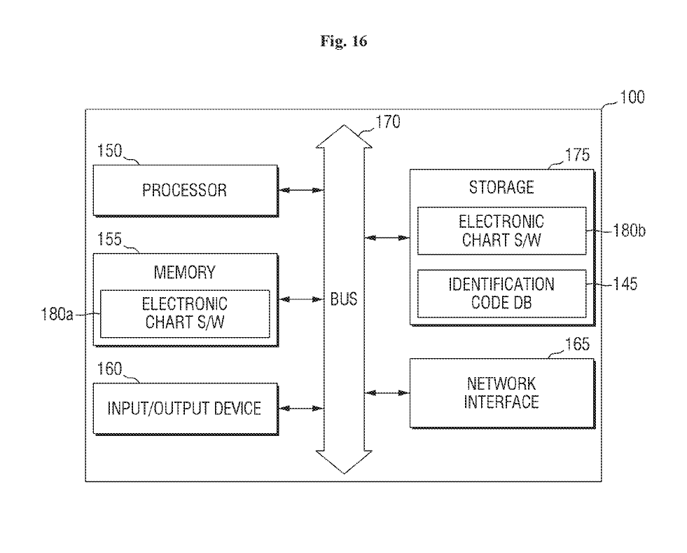

A logic configuration of the electronic chart device 100 according to an embodiment of the present inventive concept will now be explained in detail with reference to FIGS. 15 and 16.

FIG. 15 is a block diagram of the electronic chart device 100 according to an embodiment of the present inventive concept. Referring to FIG. 15, the electronic chart device 100 may include a communication unit 105, a storage unit 110, an input unit 115, an output unit 120, an identification code assigning unit 125, an automatic complete function performing unit 130, a corpus movement unit 135 and a medical ontology update unit 140.

The communication unit 105 may transmit/receive data to/from a medical ontology server 200 or an electronic chart storage server 300 through a network.

The storage unit 110 may store therein data required for operating the electronic chart device 100. The storage unit 110 may include an identification code DB 145. In this case, the identification code DB 145 may store therein identification codes designated in the international statistical classification of diseases and related health problems (ICD), logical observation identifiers names and codes (LOINC), systematized nomenclature of medical clinical terms (SNOMED-CT), US-specific terminology in medicine (i.e., RxNorm) and the like, but the present disclosure is not limited thereto.

The input unit 115 may take, as an input, data required for operating the electronic chart device 100. Specifically, the input unit 115 may take, as an input, a character string from a user. The input unit 115 may take, as an input, a movement of the position of a corpus from a user. Furthermore, the input unit 115 may take, as an input, the type of the disease of a patient or the condition of a patient. The input unit 115 may take, as an input, data through a keyboard, a mouse, a joystick, a trackball, a touch pad, a touch screen, a sensor and the like, but the present disclosure is not limited thereto.

The output unit 120 may output data associated to an operation of the electronic chart device 100. More specifically, the output unit 120 may output a character string input through the input unit 115. The output unit 120 may output a corpus transferred from the corpus movement unit 135. Furthermore, the output unit 120 may output a corpus according to an automatic complete function transferred from the automatic complete function performing unit 130. The output unit 120 may output data through a liquid crystal display (LCD), a light emitting diode, (LED), an organic LED (OLED), an active matrix OLED (AMOLED), a speaker, a vibration motor and the like, but the present disclosure is not limited thereto.

The identification code assigning unit 125 may assign, based on the identification code DB 145, an identification code to a word contained in a character string input through the input unit 115 according to the type of the word. Furthermore, the identification code assigning unit 125 may output words having identification codes assigned thereto in colors differentiated by the type of the assigned identification codes.

The automatic complete function performing unit 130 may provide an automatic complete function by using a medical ontology. More specifically, the automatic complete function performing unit 130 may extract, from the medical ontology, one or more corpora expected to be input into an electronic chart by a user on the basis of the identification codes assigned by the identification code assigning unit 125. The automatic complete function performing unit 130 may provide an automatic complete function by using the extracted one or more corpora.

The corpus movement unit 135 may provide a user interface that can freely move the position of one or more corpora output by the automatic complete function performing unit 130. More specifically, the corpus movement unit 135 may receive, from the input unit 115, an input for selecting a corpus to be moved and select a corpus to be moved. In this case, the input for selecting a corpus to be moved may include a click, a touch, a drag, a tick in a check box and the like, but the present disclosure is not limited thereto. Furthermore, the corpus movement unit 135 may receive, through the input unit 115, an input for moving the selected corpus, and move the corpus. In this case, the input for moving the selected corpus may include a drag and drop, a preset key input and the like, but the present disclosure is not limited thereto. Furthermore, the corpus movement unit 135 may receive an input for deleting an unnecessary corpus and delete the selected corpus.

The medical ontology update unit 140 may update a medical ontology on the basis of one or more words contained in a corpus and a relative position between the words. More specifically, the medical ontology update unit 140 may update the new word contained in a corpus such that the new word becomes a new instance of the medical ontology. Furthermore, the medical ontology update unit 140 may update the relative position between the words such that the relative position becomes a relation between instances.

In the description thus far, each component shown in FIG. 5 may mean software or hardware such as a field-programmable gate array or an application-specific integrated circuit (ASIC). However, the components may not be construed as being limited to software or hardware, and may be configured to exist in an addressable storage medium, or to execute one or more processors. Functions provided in the components may be implemented by further subdivided components, and a plurality of components may be integrated into a single component that performs a specific function.

FIG. 16 illustrates a configuration of hardware of the electronic chart 100 according to an embodiment of the present inventive concept. Referring to FIG. 16, the electronic chart 100 may include a processor 150, a memory 155, an input/output device 160, a network interface 165, a data bus 170 and a storage 175.

Computer program data 180a in which a method for providing an electronic chart is implemented may reside in the memory 155. The input/output device 160 may receive, as an input, data required for operating the electronic chart 100 from a user, and output data associated with an operation of the electronic chart 100. The network interface 165 may transmit/receive data through a network. The data bus 170 may be connected to the processor 150, the memory 155, the input/output device 160, the network interface 165 and the storage 175 so as to serve as a movement path for transferring data among the components.

The storage 175 may store therein an application programming interface (API), a library file, a resource file and the like required for executing a computer program. Furthermore, the storage 175 may store therein computer program data 180b in which a method for providing an electronic chart is implemented, and an identification code DB 145.

More specifically, the storage 175 may store therein a computer program including an instruction for providing a user interface that can move the position of one or more corpora contained in an electronic chart to other position, an instruction for receiving, as an input, a movement of the position of one or more corpora through a user interface, and an instruction for updating a medical ontology on the basis of one or more words contained in one or more corpora.

Furthermore, the storage 175 may store therein a computer program including an instruction for taking, as an input, a character string for creating an electronic chart from a user, an instruction for assigning identification codes to the respective words contained in the character string on the basis of the type of words, an instruction for extracting one or more corpora from the medical ontology on the basis of identification codes, and an instruction for providing an automatic complete function by using one or more corpora.

Furthermore, the storage 175 may store therein a computer program including an instruction for taking, as an input, the type of a disease to be inputted into the electronic chart, an instruction for extracting words on the basis of the type of the diseases from the medical ontology, an instruction for generating a template for creating the electronic chart on the basis of the extracted words, and an instruction for outputting the template.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method for providing an electronic chart, the method comprising:
providing, by an electronic chart device, the electronic chart including a user interface capable of moving a position of a corpus contained in the electronic chart to another position in the electronic chart, the corpus containing one or more words;
receiving, by the electronic chart device, an input for moving the position of the corpus through the user interface; and
updating, by the electronic chart device, a medical ontology based on the one or more words contained in the corpus.

2. The method of claim 1, wherein the updating the medical ontology comprises storing:
information describing a relationship between the one or more words contained in the corpus for a user that creates the electronic chart; or
information describing a relationship between the one or more words contained in the corpus for a type of disease.

3. The method of claim 1, wherein the corpus is of a plurality of corpora, and wherein the receiving the input for moving the position of the corpus comprises:
receiving, through a drag input to the corpus from among the plurality of corpora, a selection of the corpus; and
receiving, through a drag and drop input to the corpus, an input for moving the corpus to the other position in the electronic chart.

4. The method of claim 1, wherein the corpus is of a plurality of corpora, and wherein the receiving the input for moving the position of the corpus comprises receiving a selection of a check box corresponding to the corpus from among the plurality of corpora.

5. The method of claim 1, wherein the corpus is a first corpus of a plurality of corpora, and wherein the receiving the input for moving the position of the corpus comprises:
receiving a selection of the first corpus;
receiving an input corresponding to a transposition function; and
performing the transposition function,
wherein the transposition function comprises transposing positions of the first corpus and a second corpus adjacent to the first corpus.

6. The method of claim 1, wherein the receiving the input for moving the position of the corpus comprises receiving an input for deleting the corpus.

7. The method of claim 1, further comprising, after the receiving the input for moving the position of the corpus:
receiving, by the electronic chart device, an additional input, the additional input being a character string, and
outputting, by the electronic chart device, a message indicating an omission from the electronic chart based on the medical ontology when an expected character string is not input.

8. The method of claim 1, wherein the updating the medical ontology comprises adding a word as a new instance of the medical ontology,
wherein the word is among the one or more words contained in the corpus, and
wherein the word does not correspond to an instance already stored in the medical ontology.

9. The method of claim 1, wherein the updating the medical ontology comprises updating information describing a relationship between two or more words stored in the medical ontology based on a relative distance between two or more words contained in the corpus.

10. A method for providing an electronic chart, the method comprising:
receiving as an input, by an electronic chart device, a character string for creating the electronic chart, the character string containing one or more words;
assigning, by the electronic chart device, identification codes to each of the one or more words contained in the character string based on a word type of each of the one or more words, respectively;
extracting, by the electronic chart device, a corpus from a medical ontology based on the identification codes; and
providing, by the electronic chart device, an automatic complete function by using the corpus.

11. The method of claim 10, wherein the extracting the corpus comprises extracting, from the medical ontology, an expected corpus based on the identification codes.

12. The method of claim 11, wherein the expected corpus includes at least one from among a word, a sentence and a paragraph extracted from the medical ontology in association with the identification codes, from among a group of words, sentences and paragraphs from the medical ontology that are associated with the character string in the medical ontology.

13. The method of claim 10, wherein the assigning the identification codes comprises outputting the one or more words contained in the character string to which the identification codes are assigned in one or more colors corresponding to the identification codes.

14. A method for providing an electronic chart, the method comprising:
receiving as an input, by an electronic chart device, a type of a disease to be input into the electronic chart;
extracting, by the electronic chart device, a word based on the type of the disease from a medical ontology;
creating, by the electronic chart device, a template for creating the electronic chart based on the word; and
outputting, by the electronic chart device, the template.

15. A non-transitory computer readable medium having a computer program recorded thereon, the computer program comprising instructions so as to:
enable an electronic chart device to provide a user interface capable of moving a position of a corpus contained in an electronic chart to another position in the electronic chart, the corpus containing one or more words;
enable the electronic chart device to receive an input for moving the position of the corpus through the user interface; and
enable the electronic chart device to update medical ontology based on the one or more words contained in the corpus.

16. An electronic chart device comprising:
one or more processors;
a network interface;
a memory; and
a storage having a computer program recorded therein, the computer program being loaded to the memory and executed by the processors,
wherein the computer program comprises:
an instruction for providing a user interface capable of moving a position of a corpus contained in an electronic chart to another position in the electronic chart, the corpus containing one or more words;
an instruction for receiving an input for moving the position of the corpus through the user interface; and
an instruction for updating medical ontology based on the one or more words contained in the corpus.
